(19) United States
(12) Patent Application Publication
(10) Pub. No.: US 2007/0274609 A1
(43) Pub. Date: Nov. 29, 2007

(54) Image Search Apparatus, Image Search System, Image Search Method, and Program for Executing Image Search Method

(75) Inventors: Takehiro Hirai, Ushiku (JP); Kazuo Aoki, Hitachinaka (JP); Kenji Obara, Kawasaki (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi High-Technologies Corporation, Minato-ku (JP)

(21) Appl. No.: 11/751,891

(22) Filed: May 22, 2007

(30) Foreign Application Priority Data
May 23, 2006 (JP) 2006-143012

(51) Int. Cl. G06K 9/54; G06K 9/00

(52) U.S. Cl. 382/305; 382/147

(57) ABSTRACT

An object of this invention is to realize, in a semiconductor defect review apparatus, a function of easily searching for an image similar to a reference image at high speed. To this end, an embodiment of this invention has a function of saving, as text information, pieces of information accompanying an image such as acquisition date and time, an acquisition condition, the result of analyzing a piece of information other than the image, and a user's comment, in association with the image. The embodiment is configured to narrow down similar image candidates by a keyword search using the pieces of accompanying information, calculate similarity of each image to a search reference image on the basis of the features of the image, and output search results in descending order of similarity.

### BACKGROUND OF THE INVENTION

1. Field of the Invention

The present invention relates to a method and apparatus for searching through a database for a similar image at high speed and, more particularly, to a method and apparatus applicable to an observation apparatus, such as a semiconductor defect review apparatus or an inspection apparatus with a review function, which is desired to search through a large amount of image data for a similar image and output the image.

2. Background Art

In order to ensure high yield in the manufacture of semiconductors, it is important to early find a defect caused by the manufacturing process and provide a remedy for the defect. In recent years, along with semiconductor miniaturization, defects which affect yield have been diversified, and the amount of information required to explore remedies has been increasing.

A semiconductor defect review apparatus is an apparatus intended to acquire such diverse information and can output defect distribution on a wafer (hereinafter referred to as a wafer map), various types of electron microscope images (hereinafter referred to as SEM images), an optical microscope image (hereinafter referred to as an OM image), an EDX spectrum image (hereinafter referred to as an EDX result), a defect classification result (hereinafter referred to as an ADC result, which will hereinafter also refer to a manual classification result in spite of the fact that ADC originally stands for automatic defect classification), defect size distribution (hereinafter referred to as size distribution), and the like. Examples of an SEM image include an upper detector image (hereinafter referred to as a top image), a left detector image (hereinafter referred to as a left image), a right detector image (hereinafter referred to as a right image), and a tilted image (hereinafter referred to as a tilt image). Other pieces of information required to explore remedies include accompanying information bearing magnifications and optical conditions for various types of SEM images and additional information bearing information such as the result of exploring remedies after data analysis.

In semiconductor manufacturing process management using a semiconductor defect review apparatus, if a problem which requires a remedy such as an increase in the number of defects or a specific defect occurs, a previous similar case serves as important data for exploration of remedies. That is, if a defect similar to currently occurring defects had previously occurred, the probability is high of effectively coping with the defects using the same remedy as that for the defect. One of previous similar case searches is a similar image search. In a general similar image search, although features of each image are calculated, and similarity is calculated from feature distribution, this method requires long computing time. Also, there is a gap between similarity obtained by computing and similarity based on user's senses.

JP Patent publication (Kokai) No. 11-96368 A (1999) discloses a method for shortening computing time by simplifying a feature. JP Patent publication (Kokai) No. 2002-318812 A (2002) discloses a method for shortening computing time by converting a feature into text and a method for filling the gap between similarity obtained by computing and user's senses by enabling a user to correct the text into which the feature is converted.

Although JP Patent publication (Kokai) No. 11-96368 A (1999) discloses a method for shortening computing time by simplifying a feature, more particularly an external shape, the shortening of computing time has only a limited effect on an SEM image handled by a semiconductor defect review apparatus. This is because in an SEM image, an external shape is only one of a large number of features, and each image is characterized by a combination of a large number of features.

JP Patent publication (Kokai) No. 2002-318812 A (2002) discloses a method for shortening computing time for similarity calculation by converting in advance a feature into text information. In a complicated case such as one where an image is characterized by distribution of a plurality of features, conversion of features into text information is difficult, and a user who is well informed about correspondences between a combination of features and text information needs to make adjustments. The patent publication also discloses a method for filling the gap between similarity obtained by computing and user's senses by enabling a user to change text information into which features are converted. However, only a user who is well informed about correspondences between a plurality of features and text information can make full use of the method. An apparatus used by a large number of users, more particularly a semiconductor defect review apparatus needs to be easy to use under uniform standards, and thus, the methods have a limited effect.

### SUMMARY OF THE INVENTION

The present invention has been made in consideration of the above-described problems, and has as its object to provide an image search apparatus and an image search method which realize a function of easily searching for an image similar to a reference image at high speed.

In order to solve the above-described problems, according to an aspect of the present invention, there is provided an image search apparatus which searches for an image related to a reference image, comprising storage means for storing a plurality of pieces of sample image information, each having a sample image and a piece of accompanying information indicating a condition under which the image is acquired, first search means for acquiring, from the storage means, a corresponding one of the sample images which meets one of the pieces of accompanying information entered as a search criterion, and result presentation means for presenting a search result obtained from the first search means.

The apparatus has a function of saving, as text information, pieces of information accompanying an image such as acquisition date and time, an acquisition condition, the result of analyzing a piece of information other than the image, and a user's comment, in association with the image. The apparatus is configured to narrow down similar image candidates by a keyword search using the pieces of accompanying information, calculate similarity of each image to a search reference image on the basis of the features of the image, and output search results in descending order of similarity.

The apparatus further comprises second search means for performing a similarity search based on image feature distribution among the acquired sample image as the search result obtained from the first search means and acquiring one of the acquired sample image which has a predetermined degree of similarity, and the result presentation means presents a search result obtained from the second search means.

Each of the pieces of accompanying information comprises sample acquisition date and time, a sample-related device name, and a sample-related process name.

Each of the pieces of sample image information further has a piece of additional information comprising details of a remedy for a defect extracted from the sample image in the piece of sample image information and a remedy result which is a result of providing the remedy for the defect, and the first search means acquires, from the storage means, a corresponding one of the sample images which meets one of the pieces of accompanying information and/or one of the pieces of additional information entered as a search criterion.

Further features of the present invention will be apparent from the detailed description of the preferred embodiments and the accompanying drawings.

According to the present invention, it is possible to narrow down sample images among which a search is performed using a piece of accompanying information (in which human subjectivity has no place) indicating a condition under which an image is acquired instead of information obtained by analyzing the image and search for an image similar to a search reference. Accordingly, a similar image can be easily searched for at high speed, and working efficiency can be improved.

### BRIEF DESCRIPTION OF THE DRAWINGS

FIG. 1 is a block diagram showing the basic configuration of an SEM defect review apparatus;

FIG. 2A is a diagram showing an example of connection of a defect review system to a network in a case where an image search function is added to each of defect review apparatuses;

FIG. 2B is a diagram showing an example of connection of a defect review system to a network in a case where an image management server which collectively manages pieces of image information and image viewers are introduced for a plurality of defect review apparatuses;

FIG. 2C is a diagram showing an example of connection of a defect review system to a network in a case where an image search function is added to each of defect review apparatuses, and an image management server and image viewers are introduced;

FIG. 3 is a flow chart for explaining the outline of a similar image search process;

FIG. 4 is a view for explaining the concrete concept of a similar image search;

FIG. 5 is a display example of a similar image search GUI according to an embodiment of the present invention; and

FIG. 6 is an example of a GUI which displays the detailed information on a similar image.

### DETAILED DESCRIPTION OF THE PREFERRED EMBODIMENTS

An embodiment of the present invention will be described in detail below with reference to the accompanying drawings.

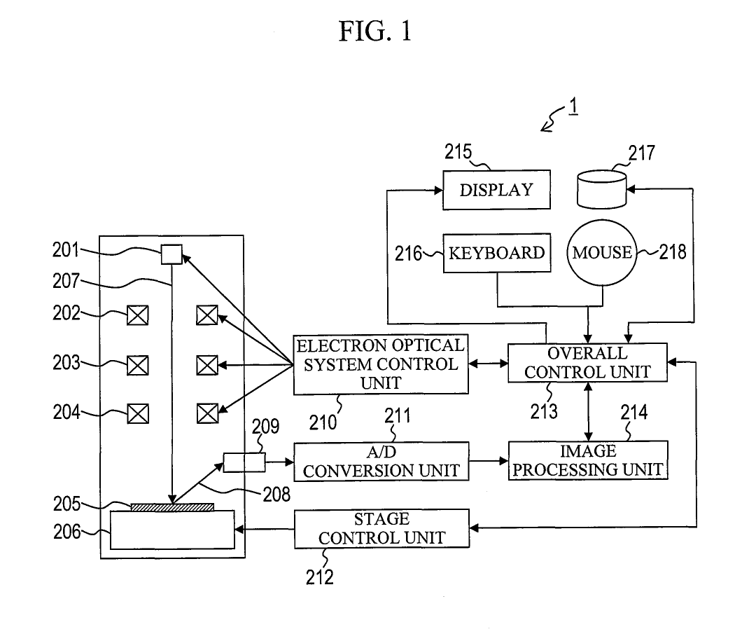

FIG. 1 is a diagram showing the configuration of a semiconductor defect review apparatus according to the embodiment of the present invention. In FIG. 1, a semiconductor defect review apparatus 1 is composed of an electron gun 201, lenses 202, deflectors 203, objective lenses 204, a sample 205, a stage 206, a secondary particle detector 209, an electron optical system control unit 210, an A/D conversion unit 211, a stage control unit 212, an overall control unit 213, an image processing unit 214, a display 215, a keyboard 216, a storage device 217 which stores sample data to be searched and a processing program, a mouse 218, and the like.

An electron beam 207 emitted from the electron gun 201 is focused by the lenses 202 and deflected by the deflectors 203. After that, the electron beam 207 is focused by the objective lenses 204 and comes incident on the sample 205. When the sample 205 is irradiated with the electron beam 207, a secondary particle 208 such as a secondary electron or reflection electron corresponding to the shape and material of the sample 205 is generated from the sample 205. The generated secondary particle 208 is detected by the secondary particle detector 209. The detected secondary particle 208 is converted from an analog signal into a digital signal by the A/D conversion unit 211, and an SEM image is formed. The formed SEM image is subjected to image processing such as defect detection in the image processing unit 214.

The lenses 202, deflectors 203, and objective lenses 204 are controlled by the electron optical system control unit 210. Position control of the sample is performed by the stage 206 controlled by the stage control unit 212. The overall control unit 213 interprets an input from the keyboard 216, mouse 218, or storage device 217, controls the electron optical system control unit 210, stage control unit 212, image processing unit 214, and the like, and outputs a processing result to the display 215 or storage device 217, as needed. The storage device 217 stores a received SEM image and accompanying information including an electron optical condition under which the image is acquired and the identification number (ID) of the semiconductor defect review apparatus as sample image information.

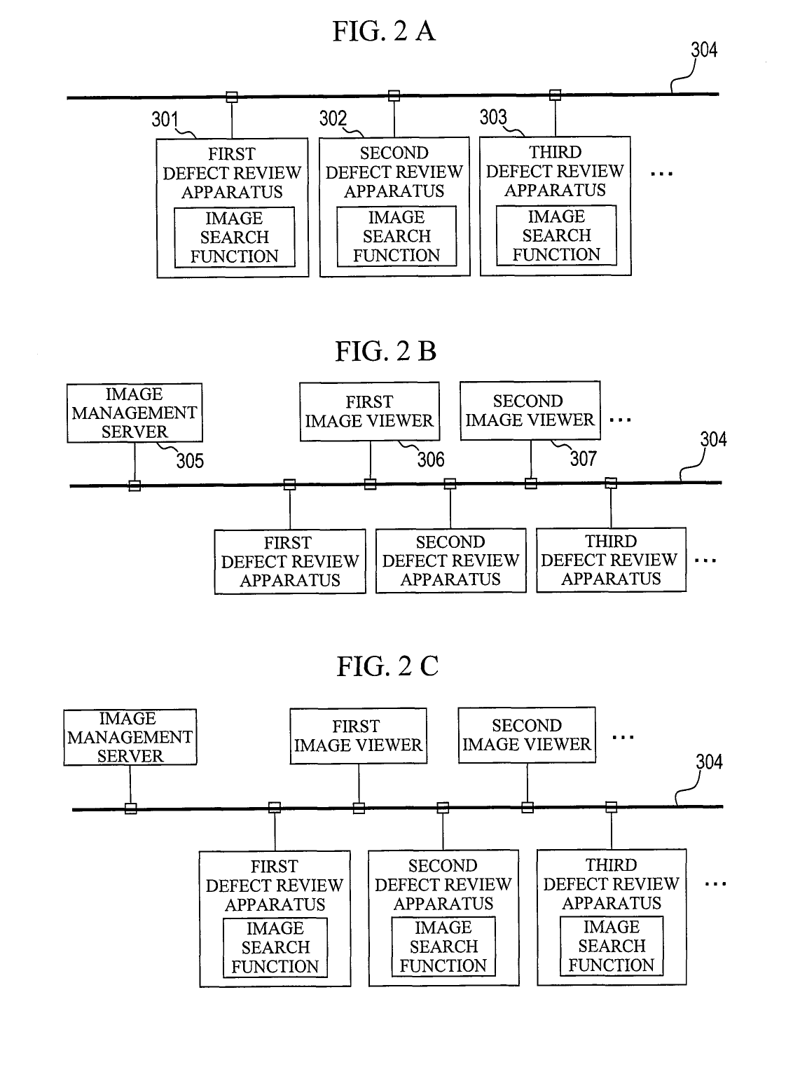

FIGS. 2A to 2C are diagrams showing examples of a network configuration including a plurality of semiconductor defect review apparatuses and image search functions according to this embodiment. In FIG. 2A, semiconductor defect review apparatuses 301, 302, and 303 are connected over a network 304. Each semiconductor defect review apparatus is equipped with an image search function. If only a small number of semiconductor defect review apparatuses are introduced into a semiconductor manufacturing line, there is no need to introduce an image management server as in FIG. 2B, and initial investment can be held down.

FIG. 2B is an example in which each semiconductor defect review apparatus is not equipped with an image search function, and an image management server 305 connected to the network 304 centrally manages an image search function. The example has the advantage of being capable of centrally managing an image search function if introduction of a large number of semiconductor defect review apparatuses is expected. Additional introduction of image viewers 306 and 307 makes it possible to check an image, perform a similar image search, or check a previous search result even from a place distant from where the semiconductor defect review apparatuses and image management server are installed. An SEM image and sample image information such as accompanying information acquired by each semiconductor defect review apparatus may be stored in the storage device 217 shown in FIG. 1 of the semiconductor defect review apparatus or may be stored in a storage device (not shown) provided in the image management server 305.

FIG. 2C is an example in which each semiconductor defect review apparatus is equipped with an image search function, and an image management server capable of collectively managing images and image viewers capable of searching for an image from a place other than where the apparatuses are installed are introduced.

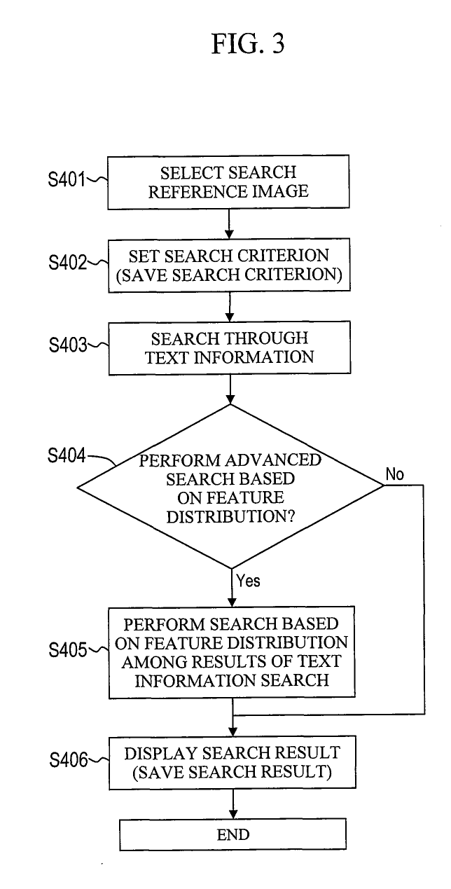

FIG. 3 is a flow chart for explaining the outline of a similar image search process. Note that the overall control unit 213 in FIG. 1 or the image management server 305 in FIG. 2B plays a central role in control of each step in the flow chart, unless otherwise specified. A program corresponding to the flow chart is stored in the storage device 217 or the storage device (not shown) of the image management server 305.

In FIG. 3, an image serving as a search reference (e.g., an image of a part with a defect) is first selected (S401), and a search criterion is set (S402). The search criterion setting will be described in detail later. Note that it is possible to save the search criterion and easily set the search criterion from the next time by loading the saved criterion.

A search is then performed through text information using the search criterion (S403). If an advanced search based on feature distribution is also to be performed (S404), a similarity search based on feature distribution is performed only among similar image candidates narrowed down by the text search in S403 (S405). Examples of a similarity search method based on feature distribution include a method for calculating feature vectors of images and evaluating the distances between the feature vectors in feature vector space as similarity and a method for evaluating similarity using a neural network. In this embodiment, if automatic defect classification (ADC) is already performed, features are already calculated, and feature vector calculation is unnecessary. Since the ADC algorithm is optimized for user classification definitions, it is possible to minimize the gap between a computing result and user's senses by applying the ADC algorithm to similarity determination. Search results are arranged in descending order of similarity (S406). Note that similarity is determined by performing image processing and feature analysis. A text search is performed not to determine similarity itself but to narrow down images among which a similarity search is to be performed.

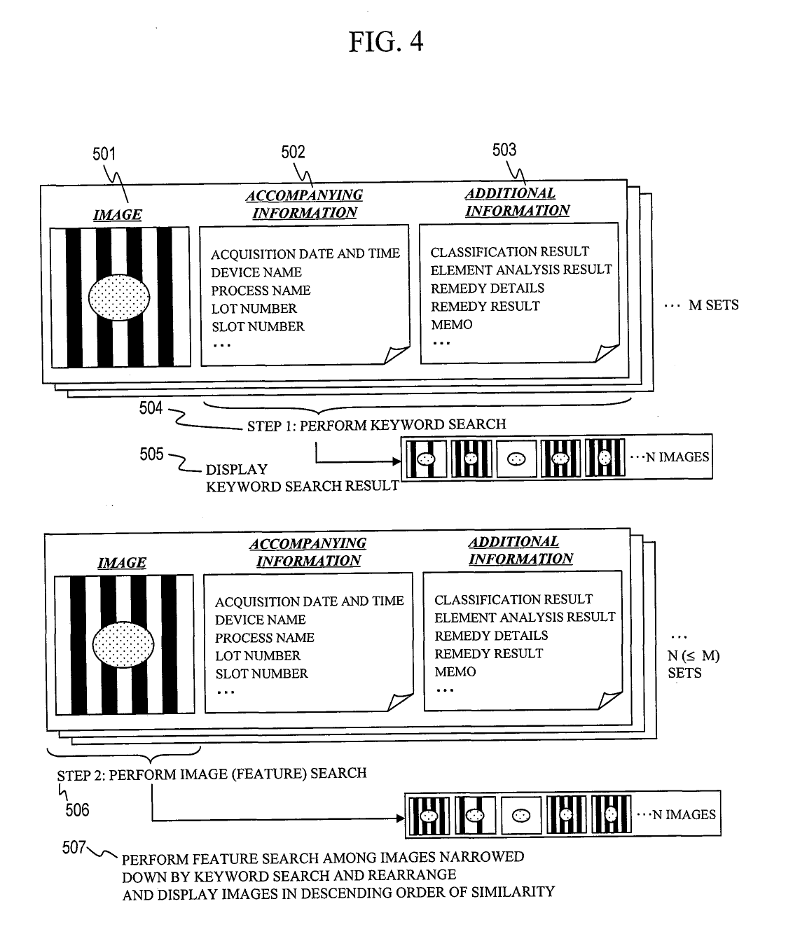

The similar image search process will be explained more specifically. FIG. 4 is a view for more specifically explaining the concept of a similar image search.

In FIG. 4, data of one of M defect samples (one piece of sample data) is composed of an image 501, accompanying information 502, and additional information 503. The components are stored in a storage device in association with one another. The accompanying information 502 is saved as information accompanying an image at the time of acquisition of the image and is composed of image acquisition date and time, the device name of the image data, the process name of the image data, the lot number of the image data, the slot number of the image data, the wafer number of the image data, an SEM image acquisition condition (e.g., a magnification or mode), an optical microscope image acquisition condition (e.g., a magnification), and the like. The reason why a search by acquisition date and time is enabled is that technology is rapidly advancing in the field of semiconductors and that there is no point in searching for excessively old information. The reason why a search by device name and process name is enabled is that a semiconductor apparatus manufactures various types of products, and the search by device name and process name is intended to narrow down candidates by the names. The accompanying information has not been subjected to conversion by computing or the like or conversion based on a user's knowledge and thus is common information independent of a user's skill. That is, human sensibility or subjectivity has no place in the accompanying information. For this reason, keyword searches using the accompanying information can obtain stable search results, regardless of a user's skill.

The additional information 503 is composed of the classification result (ADC result) and the element analysis result (EDX result) of a defect extracted from the image, the details of a remedy for the defect registered by a user, the result of the remedy, memo information, output results from other apparatuses, and the like. If a user analyzes the features of an image containing a defect, analyzes the cause of the defect, and provides a remedy for the defect, the user stores the details of the remedy and the result of the remedy in a storage device as additional information. With this operation, when a similar defect occurs later, the details and the result of the remedy can be readily referred to by using a search system according to the embodiment of the present invention. Accordingly, it is possible to quickly cope with the occurrence of a defect. The additional information is different from the accompanying information in that human feelings or subjectivity has a place in the additional information. The reason why a search by remedy details is enabled is, for example, that it is sometimes necessary to know what result a certain remedy had produced before. The reason why a search by remedy result is enabled is that it is sometimes necessary to know a remedy which had worked before.

Referring to FIG. 4, a keyword search 504 in Step 1 is performed among M data sets, and N data sets matching a keyword are extracted. An image feature search 506 in Step 2 is performed among the extracted N data sets, and the N images are rearranged and displayed in descending order of similarity.

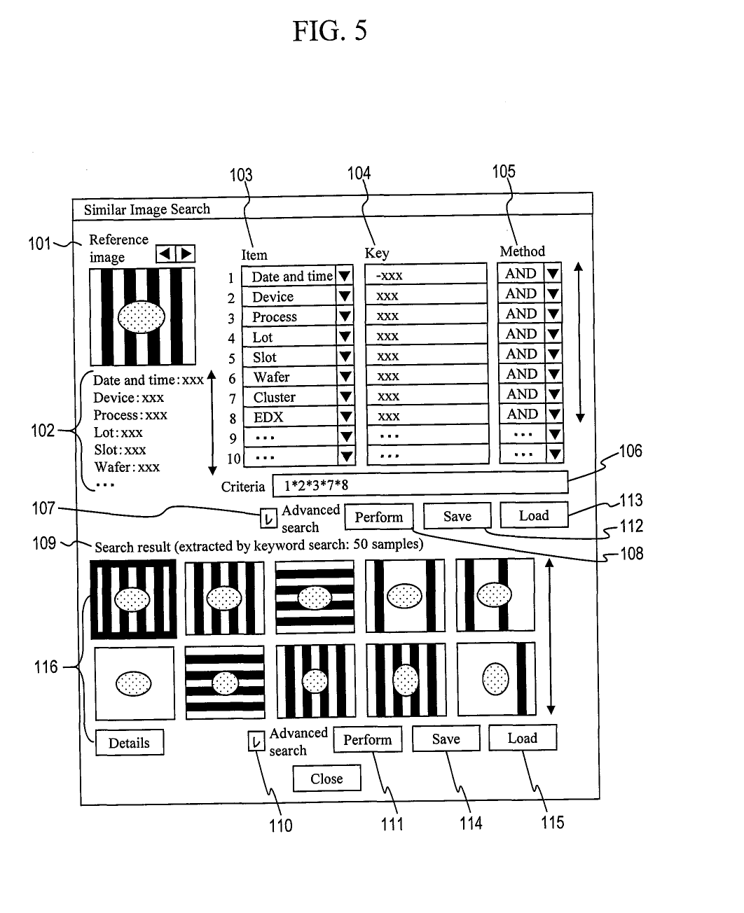

The setting of a criterion for a similar image search will be described in detail (corresponding to the process in Step S402 of FIG. 3). FIG. 5 is a view showing an example of a GUI which displays set criteria for a similar image search and search results.

An image serving as a search reference is selected in an area 101. The text information of the selected image is displayed in an area 102. In the case of a semiconductor defect review apparatus, text information is composed of accompanying information bearing image acquisition date and time, a device name, a process name, a lot number, a slot number, a wafer number, an SEM condition, and an OM condition and additional information bearing the cluster information of defect distribution obtained by analysis in another apparatus or the like, an EDX result and an ADC result, and memo information added by a user. The additional information is not information obtained by analyzing the image but information at the time of acquiring the image, and a subjective element has no place in the additional information. Of these pieces of information, classification category information is effective as information which fills the gap between similarity obtained by computing and user's senses. The classification category information is obtained by correcting, by the user, a classification result gained from ADC if necessary. Since the definitions of classification categories are common throughout the whole production line, there is no gap between users. Also, since parameters in ADC are optimized to increase the accuracy of classification according to the common classification definitions, the gap between similarity obtained by computing and user's senses is reduced.

Search criteria are set in areas 103 to 107. A text information item is selected in the area 103, a search key for the item is set in the area 104, and a logical expression (AND/OR) is selected for the search key in the area 105. Setting in the areas 103 to 105 is described using a logical expression (*/+) in the area 106. A default value for each search criterion is displayed on the basis of the information on the search reference image. A user can easily perform a basic search only by selecting a search criterion to be used in the area 106. Since a search criterion can be set in detail by using the default value for the search criterion as a basis and changing only a part thereof that needs to be changed, it is possible to efficiently perform the work of setting search criteria in a short time. If an advanced search is set to be disabled in the area 107, a text information search is performed (108) based on the criteria set in the area 106, the results of the text information search are displayed in an area 109. If the advanced search is set to be enabled in the area 107, the text information search is performed based on the criteria set in the area 106, similar image candidates are narrowed down, and a similarity search based on feature distribution is performed (108) among the remaining similar image candidates. In this case, results obtained by the combination of the text search and the feature search are displayed in the area 109.

Search results are displayed in descending order of similarity in the area 109. Since similarity evaluation which involves long-time computing is performed after images to be evaluated are narrowed down by a text information search, computing time can be made much shorter than a case where similarity evaluation is performed for all images. It is also possible to set an advanced search to be enabled in an area 110 and perform a similarity search based on feature distribution using a button 111 only if an advanced search is determined to be necessary after the advanced search is disabled in the area 107, the text information search is performed (108), and search results are checked. In this case, since the text information search is already performed, and it is only necessary to perform the similarity search based on feature distribution among images displayed as the search results, search time can be made shorter than a case where the advanced search is enabled in the area 107 and performed using the button 108. A search criterion can be saved using a button 112. Since a saved search criterion can be loaded using a button 113, it is possible to shorten the time for search criterion setting by loading a similar search criterion and changing only a part thereof that needs to be changed. Similarly, since a search result can be saved using a button 114 and can be loaded using a button 115, a search once performed need not be repeated, and the result of the search can easily be referred to in a short time. The details of each image as a search result can be displayed using a button 116. Detailed display includes an enlarged image, accompanying information, additional information, a search criterion, and a thumbnail as a search result. A detailed display screen may be activated by double-clicking an image with a pointing device such as a mouse, instead of pressing the button for detailed display.

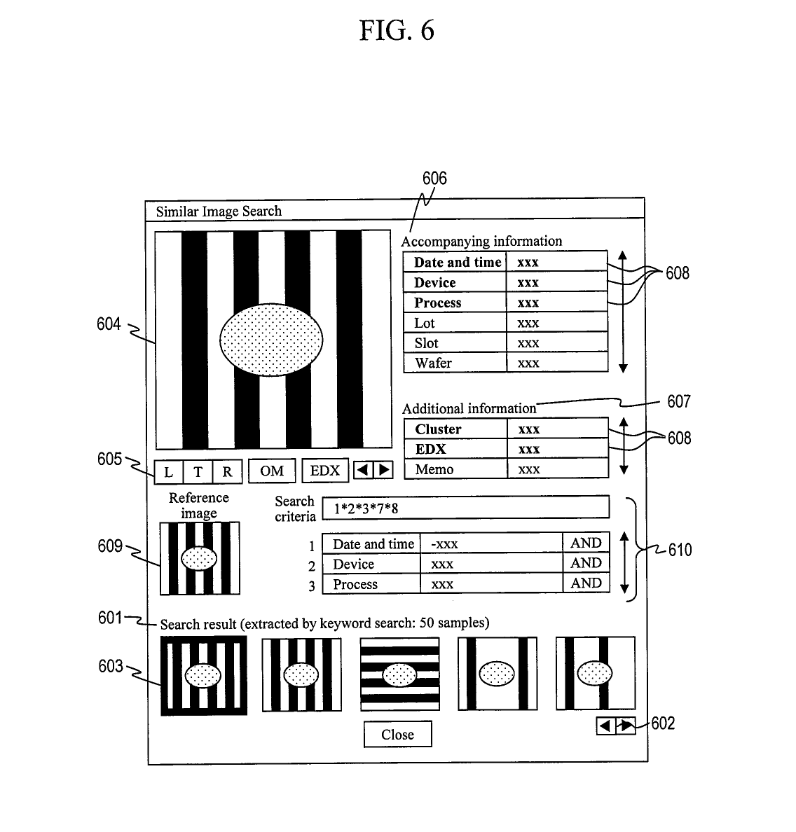

FIG. 6 is an example of a detailed display screen for a search result. When the detailed display screen is activated by selecting an image and pressing a Details button (116) or double-clicking the image in FIG. 5, thumbnails 601 of search results are displayed. The selected image can be changed to another by a mouse click or using selection buttons 602. The selected image is highlighted (surrounded by a frame) (603) and enlarged (604). If images are acquired in a plurality of modes, an enlarged image to be displayed can be switched among the images (605). Of pieces 606 of accompanying information and pieces 607 of additional information of the enlarged image, ones meeting search criteria are highlighted (displayed in boldface type) (608). It is also possible to check a search reference image 609 and search criteria 610.

Note that the present invention can also be achieved by a program code of a software program that realizes the functions of the above-described embodiment. In this case, a storage medium having the program code recorded thereon is supplied to a system or an apparatus, and a computer (or a CPU or MPU) of the system or apparatus reads out the program code stored in the storage medium. The program code itself read out from the storage medium realizes the functions of the embodiment, and the program code itself and the storage medium storing the program code each constitute the present invention. As a storage medium for supplying the program code, there may be used, for example, a floppy (registered trademark) disk, CD-ROM, DVD-ROM, hard disk, optical disk, magneto-optical disk, CD-R, magnetic tape, nonvolatile memory card, ROM, or the like.

The functions of the embodiment may also be realized by some or all of actual processes executed by an OS (operating system) running on the computer or the like in accordance with an instruction of the program code. The functions of the embodiment may further be realized by some or all of actual processes executed by the CPU or the like of the computer in accordance with an instruction of the program code read out from the storage medium after the program code is written in a memory of the computer.

The present invention may also be achieved by distributing the program code of the software program that realizes the functions of the embodiment over a network, storing the program code in storage means such as a hard disk or memory of the system or apparatus or a storage medium such as a CD-RW or CD-R, and reading out and executing the program code stored in the storage means or storage medium by the computer (or the CPU or MPU) of the system or apparatus.

What is claimed is:

1. An image search apparatus which searches for an image related to a reference image, comprising:
storage means for storing a plurality of pieces of sample image information, each having a sample image and a piece of accompanying information indicating a condition under which the image is acquired;
first search means for acquiring, from the storage means, a corresponding one of the sample images which meets one of the pieces of accompanying information entered as a search criterion; and
result presentation means for presenting a search result obtained from the first search means.

2. The image search apparatus according to claim 1, further comprising
second search means for performing a similarity search based on image feature distribution among the search result obtained from the first search means, the acquired sample image and acquiring one of the acquired sample image which has a predetermined degree of similarity, wherein
the result presentation means presents a search result obtained from the second search means.

3. The image search apparatus according to claim 1, wherein
each of the pieces of accompanying information comprises sample acquisition date and time, a sample-related device name, and a sample-related process name.

4. The image search apparatus according to claim 1, wherein
each of the pieces of sample image information further has a piece of additional information comprising details of a remedy for a defect extracted from the sample image in the piece of sample image information and a remedy result which is a result of providing the remedy for the defect, and
the first search means acquires, from the storage means, a corresponding one of the sample images which meets one of the pieces of accompanying information and/or one of the pieces of additional information entered as a search criterion.

5. The image search apparatus according to claim 4, further comprising:
search criterion saving means for saving, as a history, the piece of accompanying information or the piece of additional information entered as the search criterion; and
reading-out means for reading out, from the search criterion saving means, the piece of accompanying information or the piece of additional information as the history, wherein
the first search means acquires, from the storage means, the sample image which meets the piece of accompanying information and/or the piece of additional information read out.

6. The image search apparatus according to claim 4, wherein
the result presentation means displays, on a display unit, a combination of more than one of the reference image, a piece of accompanying information and a piece of additional information of the reference image, the search criterion, and a search result.

7. An image search system in which a plurality of image search apparatuses are connected over a network,
wherein the image search apparatuses comprise a first image search apparatus and a second image search apparatus, the second image search apparatus performing an image search among a sample in the first image search apparatus and outputting a search result on the second image search apparatus, and
each of the image search apparatuses is an image search apparatus which searches for an image related to a reference image and comprises:
storage means for storing a plurality of pieces of sample image information, each having a sample image and a piece of accompanying information indicating a condition under which the image is acquired;
first search means for acquiring, from the storage means, a corresponding one of the sample images which meets one of the pieces of accompanying information entered as a search criterion; and
result presentation means for presenting a search result obtained from the first search means.

8. An image search method for searching for an image related to a reference image, comprising:
a first search step of acquiring, from storage means, a sample image which meets a piece of accompanying information entered as a search criterion; and
a result presentation step of presenting a search result obtained in the first search step,
wherein the storage means stores a plurality of pieces of sample information, each having a sample image and a piece of accompanying information indicating a condition under which the image is acquired.

9. The image search method according to claim 8, further comprising
a second search step of performing a similarity search based on image feature distribution among the acquired sample image as the search result obtained in the first search step and acquiring one of the acquired sample image which has a predetermined degree of similarity, wherein
in the result presentation step, a search result obtained in the second search step is presented.

10. The image search method according to claim 8, wherein
each of the pieces of accompanying information comprises sample acquisition date and time, a sample-related device name, and a sample-related process name.

11. The image search apparatus according to claim 8, wherein
each of the pieces of sample image information further has a piece of additional information comprising details of a remedy for a defect extracted from the sample image in the piece of sample image information and a remedy result which is a result of providing the remedy for the defect, and
in the first search step, a corresponding one of the sample images which meets one of the pieces of accompanying information and/or one of the pieces of additional information entered as a search criterion is acquired from the storage means.

12. The image search method according to claim 11, further comprising:
a step of setting search criterion saving means for saving, as a history, the piece of accompanying information or the piece of additional information entered as the search criterion; and
a reading-out step of reading out, from the search criterion saving means, the piece of accompanying information or the piece of additional information as the history, wherein
in the first search step, the sample image which meets the piece of accompanying information and/or the piece of additional information read out is acquired from the storage means.

13. The image search method according to claim 11, wherein
in the result presentation step, a combination of more than one of the reference image, a piece of accompanying information and a piece of additional information of the reference image, the search criterion, and a search result is displayed on a display unit.

14. A program for executing an image search method for searching for an image related to a reference image, comprising:
a program code for executing a first search step of acquiring, from storage means, a sample image which meets a piece of accompanying information entered as a search criterion; and
a program code for executing a result presentation step of presenting a search result obtained in the first search step,
wherein the storage means stores a plurality of pieces of sample information, each having a sample image and a piece of accompanying information indicating a condition under which the image is acquired.

15. The program for executing an image search method according to claim 14, comprising
a program code for executing a second search step of performing a similarity search based on image feature distribution among the acquired sample image as the search result obtained in the first search step and acquiring one of the acquired sample image which has a predetermined degree of similarity, wherein
in the result presentation step, a search result obtained in the second search step is presented.

16. The program for executing an image search method according to claim 14, wherein
each of the pieces of accompanying information comprises sample acquisition date and time, a sample-related device name, and a sample-related process name.

17. The program for executing an image search method according to claim 14, wherein
each of the pieces of sample image information further has a piece of additional information comprising details of a remedy for a defect extracted from the sample image in the piece of sample image information and a remedy result which is a result of providing the remedy for the defect, and
in the first search step, a corresponding one of the sample images which meets one of the pieces of accompanying information and/or one of the pieces of additional information entered as a search criterion is acquired from the storage means.

18. The program for executing an image search method according to claim 17, further comprising:
a program code for executing a step of setting search criterion saving means to save, as a history, the piece of accompanying information or the piece of additional information entered as the search criterion; and
a program code for executing a reading-out step of reading out, from the search criterion saving means, the piece of accompanying information or the piece of additional information as the history, wherein
in the first search step, the sample image which meets the piece of accompanying information and/or the piece of additional information read out is acquired from the storage means.

19. The program for executing an image search method according to claim 17, wherein
in the result presentation step, a combination of more than one of the reference image, a piece of accompanying information and a piece of additional information of the reference image, the search criterion, and a search result is displayed on a display unit.
